(19) United States
(12) Patent Application Publication
(10) Pub. No.: US 2009/0235253 A1
(43) Pub. Date: Sep. 17, 2009

(54) Smart task list/life event annotator

(75) Inventor: Eric James Hope, Cupertino, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/075,761

(22) Filed: Mar. 12, 2008

(51) Int. Cl. G06F 9/46

(52) U.S. Cl. 718/100

(57) ABSTRACT

An annotator for monitoring a list of tasks to be performed by a person is provided. Using the annotator, a user may define a task to be performed. The task may be described by selecting values for several fields, including for example a person field, an action field, and a details field. The annotator may combined the selected values to form a sentence defining the task. When the task is complete, the annotator may automatically convert the task to a life event by changing the tense of a verb to the past tense, indicating that the task has been completed and has become an achievement. The annotator may display a listing of life events in a life events display, or may publish one or more life events to a blog, web page, or other application.

### BACKGROUND OF THE INVENTION

This invention is directed to an application for defining a task list and converting tasks into life events.

Electronic devices, for example computers, may be used to implement different types of applications. In some cases, the electronic device may be used to implement an application for assisting the user in managing time or tasks. For example, the electronic device may include a task managing application.

Using the task managing application, the user may define one or more tasks for the user, or other users, to perform. The application may organize the tasks defined by the user as a task list to which the user may refer to determine which tasks remain to be performed. When the user completes a task, the user may change an indicator, flag, or other field to indicate that the particular task has been completed.

In some embodiments, the electronic device may include an application for listing events performed by the user. For example, the electronic device may include an application for publishing life events, or other descriptions of activities performed by the user. The user may provide the events for publication by the application using any suitable approach. For example, the user may enter descriptions for events using an input mechanism associated with the electronic device. The application may publish events using any suitable approach, including for example publishing the events in an Internet page, to another application implemented on the electronic device, or any other suitable publication destination.

### SUMMARY OF THE INVENTION

An annotator for defining tasks to be performed by a user is provided. The annotator may include several display screens enabling the user to define a task. For example, the annotator may include a display screen having several fields, for each of which the user may define a value. The combination of values selected by the user may form a sentence or phrase that defines the task. The annotator may provide any suitable field for the user, including for example a person, action, importance, details, priority, and subtask field.

The annotator may be operative to determine the current status of a task defined by the user. For example, the electronic device may identify the elements of a task, and determine whether some or all of the elements have been completed. As another example, the electronic device may receive an indication from the user of the progress of the task. In some embodiments, tasks may be structured or organized (e.g., as tasks and subtasks) such that progress on a subtask is indicated as partial progress on a parent task.

When the annotator determines that a task has been completed, the annotator may convert the task into a life event. To indicate that the task has been performed (e.g., and is a life event), the annotator may change the verb tense of the task definition (e.g., from present or future to past). The annotator may then publish the life event to any suitable destination, including for example a blog, web page, Internet domain (e.g., mac account), word processing application, other electronic device application, or any other destination for publishing life events. The published life events may serve as an achievement list for the user.

### BRIEF DESCRIPTION OF THE DRAWINGS

The above and other features of the present invention, its nature and various advantages will be more apparent upon consideration of the following detailed description, taken in conjunction with the accompanying drawings, and in which:

FIG. 1 is a schematic view of an electronic device in accordance with one embodiment of the invention;

FIG. 2 is a schematic view of an illustrative display screen of an application for defining tasks in accordance with one embodiment of the invention

FIG. 3 is a schematic view of a listing of tasks defined by the user in accordance with one embodiment of the invention;

FIG. 4 is a schematic view of a life event listing in accordance with one embodiment of the invention; and

FIG. 5 is a flowchart of an illustrative process for defining a task in accordance with one embodiment of the invention.

### DETAILED DESCRIPTION

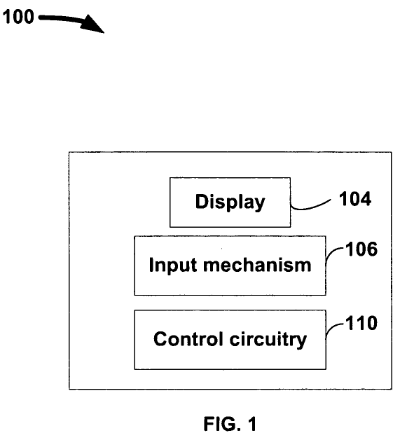

FIG. 1 is a schematic view of a electronic device in accordance with one embodiment of the invention. Electronic device 100 may include display 104, input mechanism 106, and control circuitry 110. In some embodiments, electronic device 100 may include other components, including for example, an audio output component, communications circuitry, a power supply, ports or interfaces for coupling to a host device, a secondary input mechanism (e.g., an ON/OFF switch), or any other suitable component.

Electronic device 102 may include any suitable device for receiving inputs from a user and data. For example, electronic device 102 may include a media player such as an iPod available by Apple Inc., of Cupertino, Calif., a cellular telephone, a personal e-mail or messaging device (e.g., a Blackberry® or a Sidekick®), an iPhone available from Apple Inc., pocket-sized personal computers such as an iPAQ Pocket PC available by Hewlett Packard Inc., of Palo Alto, Calif., personal digital assistants (PDAs), a desktop computer, a laptop computer, and any other electronic device (e.g., a device capable of communicating wirelessly or using a wired connection).

Display 104 may include any suitable screen or projection system for providing a display visible to the user. For example, display 104 may include a screen (e.g., an LCD screen) that is incorporated in electronic device 100. As another example, display 104 may include a movable display or a projecting system for providing a display of content on a surface remote from electronic device 100 (e.g., a video projector). Display 104 may be operative to display content (e.g., information regarding ongoing communications operations, information regarding incoming communications requests, media, or device operation screens) under the direction of control circuitry 110.

Input mechanism 106 may include any suitable mechanism for providing user inputs or instructions to electronic device 100. Input mechanism 106 may take a variety of forms, such as a button, keypad, dial, a click wheel, or a touch screen. The user interface may include a multi-touch screen such as that described in U.S. Pat. No. 6,323,846, which is incorporated by reference herein in its entirety. The user interface may emulate a rotary phone or a multi-button keypad, which may be implemented on a touch screen or the combination of a click wheel or other user input device and a screen. A more detailed discussion of such a rotary phone interface may be found, for example, in U.S. patent application Ser. No. 11/591,752, filed Nov. 1, 2006, entitled “Touch Pad with Symbols based on Mode,” which is incorporated by reference herein in its entirety. In some embodiments, input mechanism 106 may include a mechanism that is remotely coupled to display 104 or communications circuitry 110. For example, input mechanism 106 may include a keyboard, keypad, mouse, remote controller, voice-instruction apparatus, or any other mechanism for providing inputs.

Control circuitry 110 may be operative to control the operations and performance of electronic device 100. Control circuitry 110 may include, for example, a processor, a bus (e.g., for sending instructions to the other components of electronic device 100), memory, storage, or any other suitable component for controlling the operations of electronic device 100. In some embodiments, a processor may drive the display and process inputs received from the user interface or input mechanism. The memory and storage may include, for example, cache, Flash, ROM, and/or RAM. In some embodiments, memory may be specifically dedicated to storing firmware (e.g., for device applications such as an operating system, user interface functions, and processor functions).

Control circuitry 110 may be operative to execute instructions provided by firmware, software, or both implemented in electronic device 100. For example, control circuitry 110 may be operative to execute instructions provided by a communications application (e.g., an email or telephone application, or a remote access application), word processing application, a media playback application (e.g., a music, radio or video playback application), a system utility, a location-detection application, or any other suitable application for controlling operations of the electronic device. As another example, control circuitry 110 may be operative to execute instructions provided by a task list or event annotator, or other application for creating and monitoring events for users to perform.

Using an annotator, a user of the electronic device may define one or more tasks, where each task corresponds to an event to be performed. The defined tasks may require the user to perform one or more actions (viz., the task may not be completed simply by the electronic device automatically performing an operation). The annotator may display a task list that includes the tasks defined by the user (e.g., as a to-do list). As a task is completed, the annotator may convert the task to a life event, and add the life event to an achievement list.

The user may access the annotator using any suitable approach. For example, the user may launch the annotator software, or launch other software that includes the annotator by providing an appropriate instruction using the input mechanism (e.g., select an icon displayed on the display, or type a command for launching the application). The annotator may provide any suitable interface for enabling the user to provide appropriate instructions to the annotator. For example, the annotator may include a display with several options, including options for defining a task, viewing a listed of tasks defined by the user, and viewing a listing of life events.

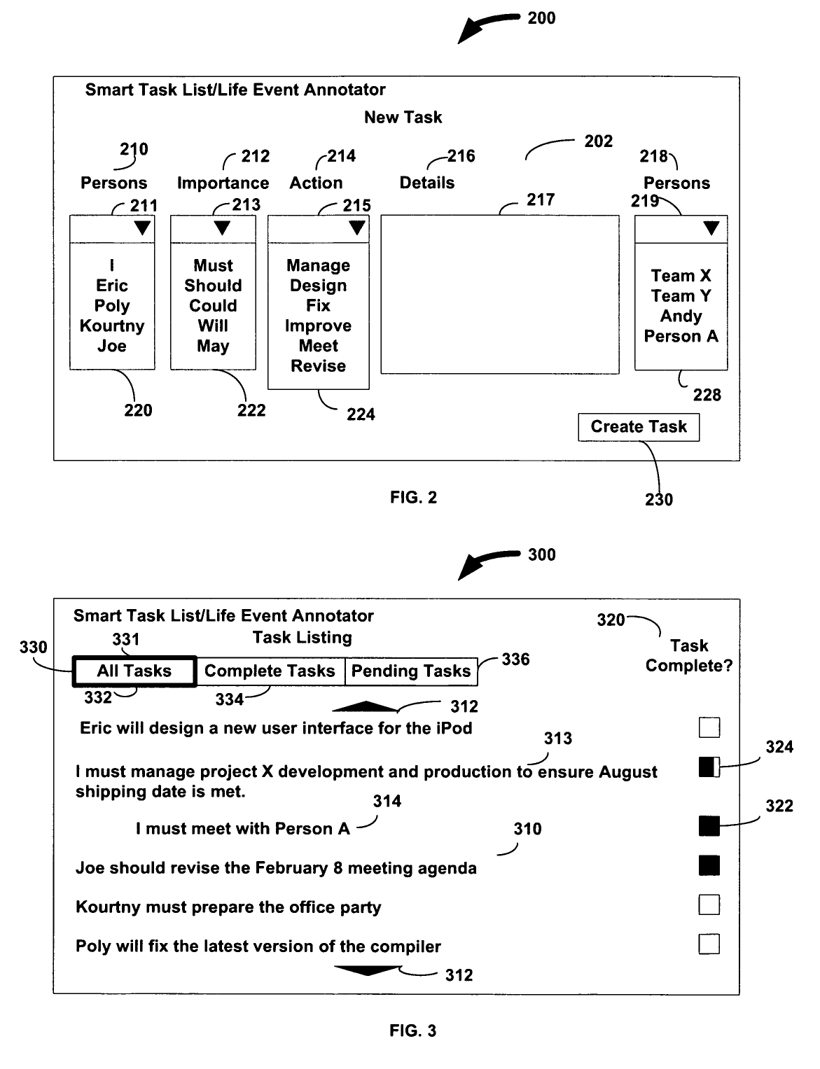

FIG. 2 is a schematic view of an illustrative display screen of an application for defining tasks in accordance with one embodiment of the invention. The user may access display 200 using any suitable approach, including for example selecting a NEW TASK option or providing an instruction using any other suitable approach. Display 200 may include fields 202 describing attributes of the task that the user may select to populate values for a task. Display 200 may include any suitable field 202. For example, display 200 may include person field 210, importance field 212, action field 214, details field 216 and a second persons field 218. In some embodiments, display 200 may include any other suitable field, including for example a field for a due date, the person creating the task, a priority, a second location field (e.g., after second persons field 218), or any other suitable field. The user may select values associated with each field to create a task (e.g., by selecting a subject, verb and complement to form a sentence describing the task). In some embodiments, the user may change the order of fields 202 (e.g., by dragging and dropping a field and values) to allow for a grammatically correct task definition (e.g., so that the task definition is accurate).

Each field 202 may be associated with several selectable values for defining a task. For example, person values 220 may be associated with person field 210, importance values 222 may be associated with importance field 212, action values 224 may be associated with action field 214, and second person values 228 may be associated with person field 218. The user may select one or more values from each set of values for each field. In some embodiments, the user may select no values for a particular field. The currently selected one or more values may be displayed in an appropriate text box associated with a field 202. For example, each of text boxes 211, 213, 215, 217 and 219 may be the value associated with each of fields 210, 212, 214, 216 and 218, respectively. If none of the displayed values are appropriate or of interest to the user, the user may directly enter an appropriate value in a text box (e.g., by typing the desired value using a keyboard). The new value may then be added to the list of displayed values placed below the text box.

Once the user has selected appropriate values for each field 202 of interest, and has fully defined the task, the user may select a create task option (e.g., option 320) to create the task. The annotator, in response to receiving the selection of option 320, may extract the values entered by the user in each text box of display 200, and combine the values to form a phrase or sentence describing the task. In some embodiments, the annotator may automatically change the grammar (e.g., verb tenses), or the order of adjectives, nouns or phrases to create a grammatically correct phrase or sentence. The annotator may then include the newly created task in a task listing display.

FIG. 3 is a schematic view of a listing of tasks defined by the user in accordance with one embodiment of the invention. Display 300 may include listing 310 of defined tasks. The tasks may be ordered using any suitable approach, including for example based on a particular value of one of fields 202, the time and date created, the user creating the task, the due date for the task, a priority, or any other suitable criteria. If more tasks have been created than are simultaneously displayed in listing 310, the display may include arrows 312 indicating that the user can scroll the listing. The user may scroll through listing 310 using any suitable approach, including for example flicking listing 310 (e.g., if the input mechanism includes a touch screen or touchpad), selecting one of arrows 312, or any other suitable approach.

Display 300 may indicate whether a particular task has been completed using any suitable approach. In some embodiments, display 300 may include boxes 320, each associated with a particular task from listing 310. The annotator may indicate that a task is not yet complete by leaving the associated box blank (e.g., box 322), and may indicate that a task is complete by changing the appearance of the associated box (e.g., darkened box 324). In some embodiments, display 300 may include an indication of the progress of a particular task. For example, a box 320 may be only partially darkened, or may be replaced by a progress bar. As another example, a separate progress bar may be displayed in addition to box 320, or may be incorporated in each listing 310.

The user may select which tasks to display in listing 310 using any suitable approach. In some embodiments, the user may select an option from tasks options 330 to select the subset of tasks to display. Tasks options 330 may include options for any suitable types of tasks or task classification, including for example All Tasks option 332, Complete Tasks option 334, and Pending Tasks option 336. In some embodiments, options for other task classifications may be displayed, including for example classification by field (e.g., field 202, FIG. 2), user, due date, or any other suitable classification. The currently selected classification may be identified by highlight region 331, or any other suitable approach.

The annotator may determine the progress of a particular task using any suitable approach. In some embodiments, users may directly indicate the status or progress of a particular task. For example, a user may select a particular task, and provide information indicating the current status of the task (e.g., update a progress bar, or change the value of a box 320). As another example, the user may modify a comments field associated with a particular task (not shown). The comments field may appear in response to a user selection of a selectable icon in the task listing (e.g., as a pop-up window, or in a new display). If several users use the same annotator, the annotator may identify the particular user who provided the status update for the task (assign a particular color or font type to comments, or display colored or shading-coded progress in the progress bar).

In some embodiments, the annotator may automatically determine and update the current status of a task. For example, the annotator may update the tasks status based on the current time (e.g., the time lapsed since the task was created, or the time remaining before the task deadline runs). As another example, the annotator may monitor documents, files, or other work product created by one or more users that relate to the particular task (e.g., monitor files tagged with a task identifier, or identify files of relevance based on their name, folders in which they are stored, or other attributes of the files). As still another example, the annotator may monitor user interactions with the electronic device (e.g., monitor a flowchart application that is revised), or with other electronic devices in communication with the annotator (e.g., monitor telephone records for communications with a party identified in the task).

In some embodiments, the annotator may organize or structure tasks defined by a user. For example, a user may define one or more subtasks associated with one or more tasks. As subtasks are completed, the progress of a parent task may be advanced (e.g., and updated in a displayed progress bar). The annotator may indicate the structure of each task using any suitable approach. In some embodiments, listing 310 may include a tree structure, or any other suitable structure to indicate that a particular task is a subtask of another (e.g., the task identified by listing 314 is a subtask of the task identified by listing 313). The structure may be collapsible, displayed over several displays or in several windows, or provided using any other suitable approach for judicially using the display. The user may define a task as a subtask of another using any suitable approach, including for example using a field 202 (FIG. 2) for defining a task.

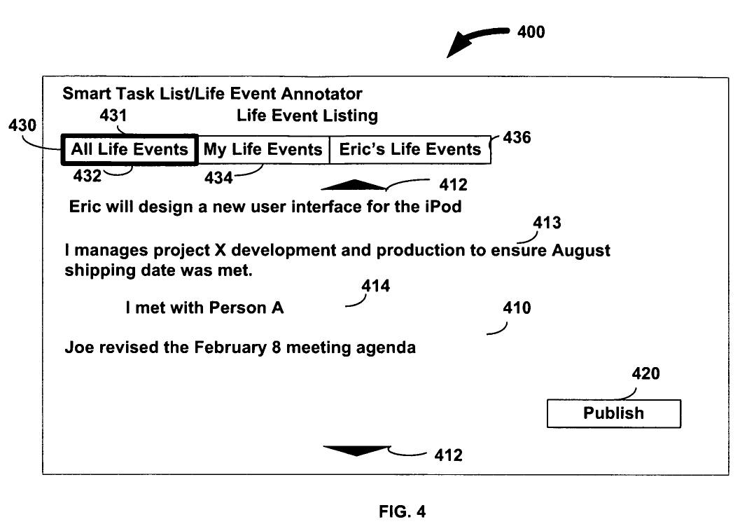

When a task is completed, the annotator may convert the task into a life event, and add the life event to a life event listing. FIG. 4 is a schematic view of a life event listing in accordance with one embodiment of the invention. Display 400 may include listing 410 of life events (i.e., tasks that have been completed). Because the life event listing may serve as a diary or as an achievement list, the annotator may convert the task from present or future tense to past tense (e.g., change the tense of the verb of action field 214, FIG. 2, or any other verb in the task definition). In some embodiments, the annotator may also remove the value of a priority field (e.g., it is no longer relevant, as the task is complete).

The user may select which life events to display in listing 410 using any suitable approach. In some embodiments, the user may select an option from life event options 430 to select a subset of life events to display. Life event options 430 may include options for any suitable types of life event or life event classification, including for example All Life Events option 332, My Life Events option 334, and Eric's Life Events option 336. In some embodiments, options for other task classifications may be displayed, including for example classification by field (e.g., field 202, FIG. 2), user, due date, or any other suitable classification. The currently selected classification may be identified by highlight region 431, or any other suitable approach.

The user may publish life events using any suitable approach. In some embodiments, the user may publish a life event listing that includes one or more life events (e.g., some or all of the life events of life event listing 410) to a blog, web page, Internet domain (e.g., .mac account), word processing application, other electronic device application, or any other destination for publishing life events. For example, the user may identify one or more life events (e.g., using a highlight region, or check boxes, not shown) and select a publish option (e.g., Publish option 420).

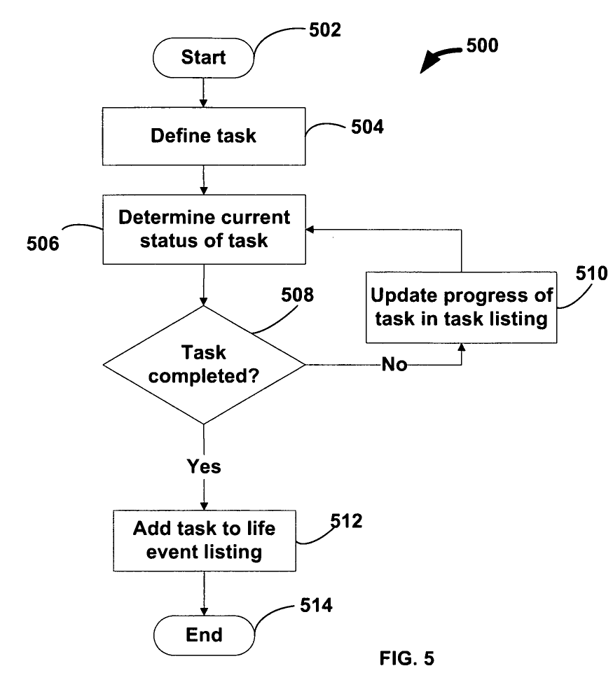

FIG. 5 is a flowchart of an illustrative process for defining a task in accordance with one embodiment of the invention. Process 500 may begin at step 502. At step 504, a task may be defined. For example, a user of the annotator may define values for several fields used to define a task (e.g., using screen 200, FIG. 2). Any suitable field may be used to define the task, including for example one or more person, importance, action, details, due date fields, or any other suitable field. The user may define one or more tasks, including for example one or more levels of subtasks for a particular task.

At step 506, the electronic device may determine the current status of a task. For example, the annotator may select a particular task, identify the components or actions defining the task, and determine the amount of the task that has been completed. The annotator may determine the current progress of the task using any suitable approach, including for example receiving an indication from the user of the progress of the task, monitoring user interactions with the electronic device or other devices coupled with the electronic device to identify interactions related to the task, or any other suitable approach. The annotator may update the progress of the task using any suitable approach. In some embodiments, the annotator may display a visual indication of the progress of the task (e.g., a progress bar in a task listing).

At step 508, the electronic device may determine whether the task was completed. For example, the electronic device may compare the status determined at step 506 with the complete task requirements. If the electronic device determines that the task was not completed, process 500 may move to step 510. At step 510, the electronic device may further update the progress of the task, for example in a progress bar in a task listing. Process 500 may then return to step 506 and determine the current status of the task.

If, at step 508, the electronic device instead determines that the task has been completed, process 500 may move to step 512. At step 512, the electronic device may add the complete task to a life event listing. For example, the electronic device may convert the task to a life event by changing relevant portions of the task definition (e.g., changing the tense of one or more verbs). The electronic device may in addition publish the life event to any suitable destination (e.g., a blog). Process 500 may then end at step 514.

The above described embodiments of the present invention are presented for purposes of illustration and not of limitation, and the present invention is limited only by the claims which follow.

What is claimed is:

1. A method for defining a task, comprising:
defining a task to be performed by a person;
determining whether the defined task is complete;
automatically converting the task to a life event in response to the determining.

2. The method of claim 1, wherein determining further comprises:
establishing the current progress of the defined task; and
comparing the established progress with the requirements of the complete task.

3. The method of claim 2, further comprising displaying a graphical representation of the established current progress.

4. The method of claim 1, wherein defining further comprises:
displaying at least one field characterizing the task; and
receiving a definition of at least one value associated with the displayed at least one field.

5. The method of claim 4, wherein displaying further comprises displaying at least one field for at least one of a person, an urgency, an action, a due date, an urgency, and details characterizing the task.

6. The method of claim 4, wherein defining further comprises setting the defined task as a subtask for a previously defined parent task.

7. The method of claim 6, wherein displaying further comprises displaying at least one field for indicating that the defined task is a subtask for the defined parent task.

8. The method of claim 1, wherein defining further comprises defining the task as a grammatically correct sentence.

9. The method of claim 8, wherein converting further comprises:
identifying at least one verb of the defined task; and
automatically converting the tense of the verb to the past tense, indicating that the defined task has been completed.

10. A method for publishing a life event listing, comprising:
identifying a defined task;
determining that the task is complete; and
automatically publishing a life event associated with the defined task.

11. The method of claim 10, wherein determining further comprises determining that a person performed the identified task.

12. The method of claim 10, further comprising converting the task to the life event in response to determining.

13. The method of claim 12, wherein converting further comprises changing the tense of at least one verb of the defined task to a past tense.

14. The method of claim 10, wherein publishing further comprises automatically publishing the life event to at least one of a blog, webpage, and text displaying application.

15. The method of claim 10, wherein determining comprises automatically determining.

16. The method of claim 10, further comprising:
detecting the requirements for completing the task;
monitoring the progress of the task; and
comparing the monitored progress with the detected requirements.

17. An annotator for displaying events, comprising:
a task display comprising a listing of tasks defined by the user and to be performed by a person; and
a life event display comprising a listing of life events, each tasks are operative to be automatically converted to a corresponding life event in response to determining that the task is complete.

18. The annotator of claim 17, wherein the task display comprises a selectable option for defining a new task.

19. The annotator of claim 18, wherein the annotator further comprises a task definition display accessed in response to receiving a selection of the selectable option.

20. The annotator of claim 19, wherein the task definition display comprises:
at least one field for defining an attribute of the task; and
at least one text box associated with the at least one field for receiving a value for the task associated with the at least one field.

21. The annotator of claim 17, wherein the life event display comprises a selectable option for publishing the life event display.

22. The annotator of claim 21, further comprising publishing at least one life event from the life event listing to at least one of a blog, webpage, and text displaying application in response to receiving a selection of the selectable option.

23. A system for defining a task, comprising control circuitry, a display, and an input mechanism, the control circuitry operative to:
receive an input from the input mechanism defining a task;
determine that the defined task is complete;
direct the display to show a listing comprising at least one life event resulting from the automatic conversion of the defined task in response to determining.

24. The system of claim 23, wherein the control circuitry is further operative to determine that a person has completed the requirements of the task.

25. The system of claim 23, wherein the control circuitry is operative to publish at least a portion of the life event listing to at least one of a blog, webpage, and text displaying application.
